(19) United States
(12) Patent Application Publication
(10) Pub. No.: US 2010/0084075 A1
(43) Pub. Date: Apr. 8, 2010

(54) Strength enhancement of carbon-carbon composite brake pads using fiber pre-stressing

(75) Inventors: Anthony J. Rutten, South Bend, IN (US); Slawomir T. Fryska, Granger, IN (US); Mark L. LaForest, Granger, IN (US); Allen H. Simpson, Buchanan, MI (US); Barry P. Soos, Mishawaka, IN (US)

Correspondence Address: HONEYWELL/BSKB;PATENT SERVICES, 101 COLUMBIA ROAD, P.O. BOX 2245, MORRISTOWN, NJ, 07962-2245, US

(73) Assignee: HONEYWELL INTERNATIONAL INC.

(21) Appl. No.: 11/580,063

(22) Filed: Oct. 13, 2006

(51) Int. Cl. B32B 5/06; C01B 31/02

(52) U.S. Cl. 156/91; 264/29.1

(57) ABSTRACT

This invention relates to an improved carbon-carbon composite material and method of preparation. The carbon-carbon composite material comprises a plurality of carbon fiber substrates that have been joined or consolidated. In the present invention, the carbon fibers are stressed during the preparation of the composite material. The invention comprises adding a low-melting point pitch to the carbon fiber substrates and heat treating the carbon fiber substrates. The fibers tend to shrink more than the pitch during heat-treatment which produces stress in the fibers. This invention enhances the strength of the composite material and improves reliability.

### FIELD OF THE INVENTION

This invention relates generally to carbon-carbon composites and methods for production thereof. More specifically, the present invention relates to a method for strength enhancement of carbon-carbon composites by pre-stressing the composites using special processing techniques. The carbon-carbon composites of this invention find application in carbon friction discs and structural bars.

### BACKGROUND OF THE INVENTION

Carbon-carbon composites are essential materials in a variety of high-technology applications requiring durability at very high temperatures. For example, carbon-carbon composites are used in the disk brakes of jet fighters and large passenger airliners due to their excellent resistance to friction, abrasion, and thermal shock. Additional applications include disk brakes of land transportation vehicles such as tanks, special vehicles, rapid transit trains and racing cars, high-temperature structures such as gas turbine blades and jet-engine parts, rocket nozzles of launch vehicles, re-entry surfaces of the space shuttle, and walls of fusion reactors and other high-temperature industrial equipment.

Carbon-carbon composites generally comprise a carbon fiber substrate (fiber component) embedded in a carbonaceous matrix (filler component). Important factors in achieving good properties are the properties of the carbon fibers, the carbon matrix microstructure, and the density of the composite. The particular processing route employed to make the carbon-carbon composite, and the choice of the carbon precursor influence the density, macrostructure, and physical properties of the material. These variables also influence the thermal transport mechanism in carbon-carbon composites.

Typically, threads, bands or fabrics are used as the fiber component. The highest strength is achieved by a straight orientation of the fibers. For most technical applications, two-dimensional (2-D) fabrics are used. If a high strength in all three directions of space is required, it is also possible to use fabrics that are woven in three directions of space, i.e. 3-D fabrics. The carbon matrix or filler component typically comprises pitch, phenolic resin, furan resin, or pyrolytic carbon using a CVD method.

The method of manufacturing carbon-carbon composites can be generally divided into a process of producing a preform using a carbon-based fiber or fabric, and a process of densifying the preform to meet the needs of the ultimate application. The preparation method also typically includes an oxidation-resistance treatment to impart durability on the finished product.

The densification can be achieved through vapor phase infiltration wherein hydrocarbon gases are used to infiltrate the composite structure heated to high temperature, and are made to crack within the structure. The composite structures can also be impregnated with a liquid phase pitch/phenolic resin followed by carbonization and high temperature heat treatment.

When the carbon-carbon composites are utilized in aircraft brakes they are required to absorb large amounts of kinetic energy in order to stop the aircraft during landing or in the event of a rejected take-off. Frequently, the carbon is heated to sufficiently high temperatures that surfaces exposed to air will oxidize. Even worse, carbon-carbon composites have open porosities (typically 5% to 10%) which permit internal oxidation. The internal oxidation weakens the material in and around the brake rotor lugs or stator slots, which are the areas that transmit the torque during braking.

In addition to the oxidation problems exhibited by carbon-carbon composites, the strength of carbon-carbon composites can be lower than what is required or optimum for many applications. When oxidation occurs, the strength of the composites is reduced limiting the application of carbon-carbon composites as structural members.

Accordingly, there is a need in the art for improved methods of producing carbon-carbon composites that exhibit higher strength, and that can withstand a greater strain before failure.

### SUMMARY OF THE INVENTION

The present invention provides an improved carbon-carbon composite material with a high strength and that can withstand a greater strain before failure. The present invention is directed to a carbon-carbon composite that comprises a plurality of carbon fibers, which are typically stacked on top of each other to a desired thickness, and are joined or consolidated to create a preform.

An important feature of the present invention is pre-stressing the carbon fibers of the carbon-carbon composite, which is usually accomplished by adding a low-melting point pitch to the carbon fibers or preform, and heat treating or charring the fibers or preform. This results in strength enhancement of the composite and greater strain to failure.

### BRIEF DESCRIPTION OF THE DRAWINGS

The present invention will become more fully understood from the detailed description given herein below and the accompanying drawing. The drawing is given by way of illustration only. Accordingly, the drawing should not be construed as limiting the present invention.

FIG. 1 is a flowchart illustration of a method for manufacturing a carbon-carbon composite material in accordance with the present invention.

### DETAILED DESCRIPTION OF THE INVENTION

The present invention is directed to an improved carbon-carbon composite material. The present invention is also directed to an improved method for preparing a carbon-carbon composite material, wherein pre-stressing the carbon fibers of the carbon-carbon composite results in strength enhancement, higher strain to failure, and improved performance and reliability.

The present invention is generally directed to a plurality of carbon fibers, which are typically stacked on top of each other to a desired thickness, and then joined or consolidated. An important feature of the invention is that the carbon fibers are stressed (or pre-stressed). Carbon fiber stressing is preferably accomplished by adding a low-melting point pitch to the carbon fibers and heat treating or charring the carbon fibers.

The carbon fibers tend to shrink more than the pitch during heat-treatment which produces a stress in the fibers. The stress produced in the fibers then places a compressive stress on the carbon matrix. This compressive stress is desirable in that any tensile stress put on the material would have to overcome the compressive pre-stress of the matrix for failure to occur. Failure of the carbon-carbon composite tends to occur either in the matrix or the fiber-matrix interface.

In a preferred embodiment of the invention, a fiber preform is created using oxidized poly-acrylonytrile (PAN) fibers or stabilized pitch fibers, and is then infused with a low melting point pitch liquid, followed by charring of the preform in order to heat treat the fibers and the pitch.

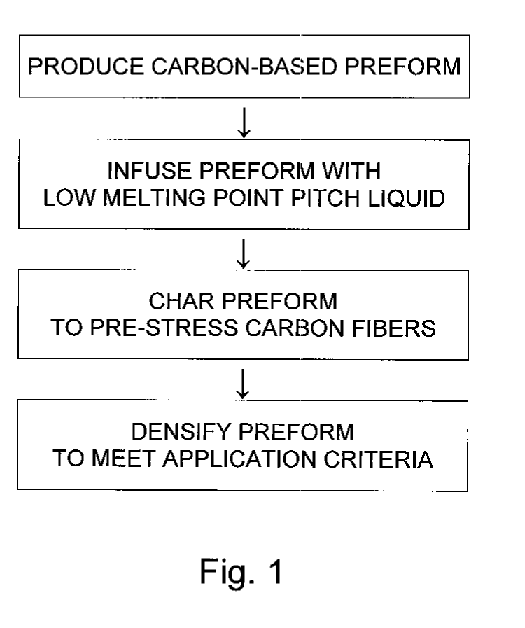

FIG. 1 shows an embodiment of the inventive method for manufacturing a carbon-carbon composite material of the present invention. To produce a conventional carbon-carbon part from a carbon fiber substrate that may be used, for example, for an aircraft brake disc, a plurality of carbon fiber substrates are available. These carbon fiber substrates typically comprise carbon fibers embedded in a carbon matrix. The substrates may be stacked on top of each other to a desired thickness and then the stacked substrates may be needle-punched together, as is known in the art, to join or consolidate the substrates to each other by intermingling carbon fibers between the layers of substrates. This consolidation of the substrates creates a preform.

After the preform is created, the carbon fibers of the preform are pre-stressed to make the bulk composite material stronger and with more strain to failure. In one embodiment of the present invention, the carbon preform is infused with a low-melting point pitch liquid. After the infusion step, the preform is charred to heat treat the fibers and the pitch. Because the fibers tend to shrink more than the pitch during heat treatment, the result is a pre-tension of the fibers, which places a compressive stress on the carbon matrix.

After the carbon fibers of the preform are pre-stressed, the manufacturing process proceeds as is typically accomplished in the art, usually by densifying the preform. Because failure of the carbon-carbon composite material is usually observed in the matrix or in the fabric-matrix interface, the compressive stress created by the method of the present invention improves the overall strength of the ultimate composite material.

In another embodiment of the method of the present invention, a fiber preform is created using oxidized poly-acrylonytrile (PAN) fibers or stabilized pitch fibers. The preform is then infused with the low-melting point pitch liquid and charred as described above.

The present invention also embodies a method for enhancing a carbon-carbon composite material by providing a fiber preform manufactured by any method known in the art and infusing said preform with a low-melting point pitch liquid followed by charring of the fiber preform. In a preferred embodiment of the present invention, the fiber preform utilized is created using oxidized PAN fibers or stabilized pitch fibers.

Low melting point pitch. The low melting point pitch usable with this invention is not particularly limited and may be any low melting point pitch that is generally known in the art for use in preparing carbon-carbon composites. For example, the pitch can be a derivative of coal tar, petroleum or synthetic pitch precursors such as synthetic pitch, coal tar pitch, petroleum pitch, mesophase pitch, high char yield thermoset resin or combinations thereof.

Carbon fibers and composites. Carbon fibers are reinforcing fibers known for their high strength and stiffness to weight ratio. Carbon fibers are usually produced by pyrolysis of an organic precursor fiber in an inert atmosphere at high temperatures. Carbon fibers may be produced from different types of materials known as precursor fibers, such as polyacrylonitrile (PAN), rayon, and petroleum pitch. The carbon fibers are typically produced by the controlled burning off of the oxygen, nitrogen, and other non-carbon parts of the precursor fiber, leaving only carbon in the fiber. Following this burning off (or oxidizing) step, the fibers are typically run through a furnace to produce fibers with the desired state of graphitization. Carbon fibers are produced at furnace temperatures of around 1,000-2,000° C., while graphite fibers typically require temperatures of around 2,000-3,000° C.

Consolidation of the carbon fibers into substrates can be done as threads, bands and fabrics for example, which can all be used as the fiber component. A high strength can be achieved by a straight orientation of the fibers. Two-dimensional (2-D) fabrics can also be used. If a high strength in all three directions of space is desirable, it is also possible to use fabrics that are woven in three directions of space, i.e., three-dimensional 3-D fabrics, with this invention.

Consolidation of the fibers into substrates can be accomplished by any of the methods conventionally known in the art. For example, the fibers can be consolidated by needle punching together segments of fabric using traditional textile processing techniques. Other methods of consolidating the preforms include stitching methods, and using a liquid or dry adhesive combined with appropriate heat and pressure.

The preparation of a carbon-carbon composite or a carbon-carbon matrix usually involves placing the carbon fibers in a carbonaceous matrix having a desired shape (a preform) followed by densification. The densification can be achieved by a variety of methods known in the art including vapor phase infiltration followed by pyrolysis. The carbon-carbon fiber matrices can also be impregnated with liquid phase pitch/phenolic resin followed by carbonization and high temperature heat treatment.

Heat treatment. The heat treatment may be performed by any of the methods generally known in the art. No special furnaces or heating regimes are required. The furnaces may be heated using induction coils or resistance heating elements. Generally the composites are heat treated in a furnace under an inert gas. Preferably, the material is first placed into the furnace and then the furnace is ramped up to the designated temperature at a maximum rate of 150° C./hour. The material is then held at the designated temperature for a period of time at which point the furnace is cooled to below 200° C., and the sample is removed and returned to room temperature.

Stress. The stress is the force per unit area on a body, and that may cause it to deform. It is a measure of the internal forces produced in a material as it resists separation, compression, or sliding in response to an externally applied force. In the present invention, a pre-stress is produced in the fibers because the fibers shrink more than the pitch during the heat treatment or charring of the carbon fiber substrates and low melting point pitch.

The pre-stress produced in the fibers places a compressive stress on the carbon-carbon composite formed from the carbon fibers. This compressive stress is desirable in that a tensile stress put on the material would have to overcome the compressive pre-stress of the composite matrix in order for failure of the carbon-carbon composite to occur.

The present invention has been described herein in terms of preferred embodiments. However, obvious modifications and additions to the invention will be apparent to those skilled in the relevant art upon reading the foregoing description. It is intended that all such modifications and additions form a part of the present invention.

1. (canceled)

2-3. (canceled)

4. The method according to claim 14 of preparing a carbon-carbon composite brake pad for an aircraft, wherein
the carbon fiber precursors comprise polyacrylonitrile (PAN) fibers or stabilized pitch fibers and
the step of heat-treating the carbon fiber precursors comprises charring the carbon fiber precursors to burn off oxygen, nitrogen, and other non-carbon elements in the precursor fibers, leaving only said pre-stressed carbon fibers.

5-13. (canceled)

14. A method of preparing a carbon-carbon composite brake pad for an aircraft which comprises the sequential steps of:
providing a plurality of carbon fiber precursor substrate layers;
stacking said carbon fiber precursor substrate layers on top of each other;
needle-punching the resulting stacked carbon fiber precursor substrates layers together to consolidate them by intermingling carbon fiber precursors between the layers of substrates to create an aircraft brake pad preform;
adding a low-melting point pitch to infiltrate the carbon fiber precursors in said aircraft brake pad preform; and then
heat-treating the carbon fiber precursors in the pitch-infiltrated aircraft brake preform, thereby producing a carbon-carbon composite brake pad having pre-stressed carbon fibers therein.
